(19) United States
(12) Patent Application Publication
(10) Pub. No.: US 2003/0184947 A1
(43) Pub. Date: Oct. 2, 2003

(54) Static arc dissipation device

(75) Inventor: Joshua Scott Soper, Orlando, FL (US)

Correspondence Address: JOSHUA SOPER, 8314 BANYAN BLVD., ORLANDO, FL, 32819, US

(73) Assignee: Mr. Joshua Scott Soper, Orlando, FL (US)

(21) Appl. No.: 10/063,168

(22) Filed: Mar. 27, 2002

(51) Int. Cl. H01G 2/00

(52) U.S. Cl. 361/301.1

(57) ABSTRACT

This device is used to discharge static electricity painlessly prior to touching an object. The device places a resistive load in the circuit lowering the rate (voltage and current) static discharges from the users body into an object. This is done by pressing touch point (A) which is connected to the object. The device can be temporary attached using magnet or sticker. The device can also by permanently attached with adhesives.

### BACKGROUND OF INVENTION

A common problem when entering and exiting a vehicle in dry cold climates is getting shocked. This is caused by ElectroStatic Discharge (ESD) between the person and the vehicle. In the electronics industry, a technician would protect the a circuit by having the static in their body discharge through a resistor. The pain involved with a static shock comes from the arc exiting the body.

### DETAILED DESCRIPTION

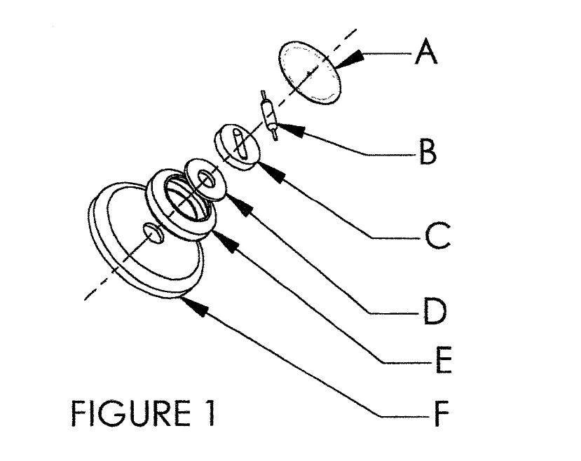

FIG. 1 shows an exploded view of the invention. The invention consists of a touch point (A), resistive circuit (B), electrical isolator (C), contact plate (D), nonconductive spring/switch mechanism, and an attachment force typically a magnet or sticker (F). To use the invention place the device on any metal object where static shock is a common problem, such as the door of an automobile. The attachment force (F) will hold the invention in place. Prior to touching the object (i.e. car) depress the touch point (A) on the invention. Any static will travel from the touch point (A) through the resistive circuit (B) and into the automobile's grounding system by way of the contact plate (D). The arc generated by the static will exit through the contact plate instead of the users finger. This effectively eliminates the static in the body with out feeling the pain of the arc of electricity leaving your fingers.

1. An electrostatic discharge device comprising,
a. a contact surface connected to a touch point by means of a resistive circuit actuated using non-conductive spring for the purpose of static removal:
b. a device for the use of translating an electrical arc from ones body to a contact surface.
